(19) United States
(12) Patent Application Publication
(10) Pub. No.: US 2022/0267101 A1
(43) Pub. Date: Aug. 25, 2022

(54) DRIVE OVER CONVEYOR FOR PEANUTS

(71) Applicant: Premium Peanut LLC, Douglas, GA (US)

(72) Inventor: Ronald Jay Myers, III, Douglas, GA (US)

(21) Appl. No.: 17/181,344

(22) Filed: Feb. 22, 2021

(51) Int. Cl. B65G 43/10; B65G 41/02

(52) U.S. Cl. CPC B65G 43/10; B65G 41/02; B65G 2201/0202; B65G 2203/0291

(57) ABSTRACT

There is disclosed a drive over conveyor system for transporting peanuts from a loading area, where peanuts are deposited from a trailer onto the conveyor belt of the drive over conveyor, to a discharge area where the peanuts are discharged from the conveyor belt of the drive over conveyor to another conveyor belt system that transports the discharged peanuts toa storage location. The speed of the drive over conveyor belt is adjusted such that the force exerted on the peanuts as they are discharged therefrom allows the peanuts to be deposited to the conveyor belt of the other conveyor belt system without the need for a hood or other apparatus to direct the peanuts from one conveyor belt to the other.

### FIELD OF THE DISCLOSURE

The present invention relates generally to peanut processing. More particularly, the present invention relates to a conveyor system for moving peanuts deposited from a trailer to another conveyor system that moves the peanuts to a storage location in a warehouse.

### BACKGROUND OF THE DISCLOSURE

After peanuts have been harvested on a peanut farm, they are delivered from the farm by a trailer to a storage warehouse, where they are stored for further processing. At the warehouse, the peanuts are removed from the trailer via a hopper on the bottom of the trailer and deposited onto the belt of a conveyor, known as a drive over conveyor. The drive over conveyor carries the peanuts to another conveyor system, called a potato hog, that carries the peanuts to their storage locations, which are typically mounds or piles of peanuts on the warehouse floor.

To date, there has not been a drive over conveyor specifically designed or suited for conveying peanuts. Rather, it has been common in the industry to use a conveyor designed for carrying other types of crops or seed, such as grain. For example, it has been common to use a conveyor such as the Crust Buster Drive Over-Pit made by Speed King Inc., such as that disclosed in the Drive Over-Pit Belt Accelerator & Multi-Purpose Belt Loader Owner's Manual (http://www.crusbuster.com/images/manuals/drive-over-pits/Drive-O_Pit_2009.pdf). These conveyors are designed to move the grain at fixed (non-adjustable), relatively high speed. In order to prevent the grain from over-shooting its intended discharge location when it reaches the end of the conveyor, these conveyors have a generally elbow shaped hood at the discharge end that directs the grain from the discharge end of the conveyor downwardly to the intended location. That is, the grain strikes the elbow of the hood and is deflected downwardly. Since the grain is not harmed as a result of striking against the hood's elbow, these conveyors work satisfactorily for their intended purpose.

However, such prior art drive over conveyors have been known to damage to peanuts, because the shells often crack when the peanuts strike the hood. This can reduce yield, and hence reduce the efficiency of the peanut processing operation. Nonetheless, the resulting reduced yield has been accepted as a cost of processing peanuts.

### BRIEF DESCRIPTION OF DRAWINGS

FIG. 1 is a perspective view of relevant portions of the prior art conveyor system discussed above.

FIG. 2 illustrates relevant details of the prior art conveyor system shown in FIG. 1.

FIG. 3 is a perspective view of a conveyor system according to the present disclosure.

FIG. 4 is another perspective view of the conveyor system of FIG. 3.

FIG. 5 is yet another perspective view of the conveyor system of FIG. 3.

FIG. 6 illustrates peanuts being discharged from the conveyor system of FIG. 3 onto a table conveyor that is part of a “potato hog”.

FIG. 7 is another view of peanuts being discharged from the conveyor system of FIG. 3 onto the table conveyor.

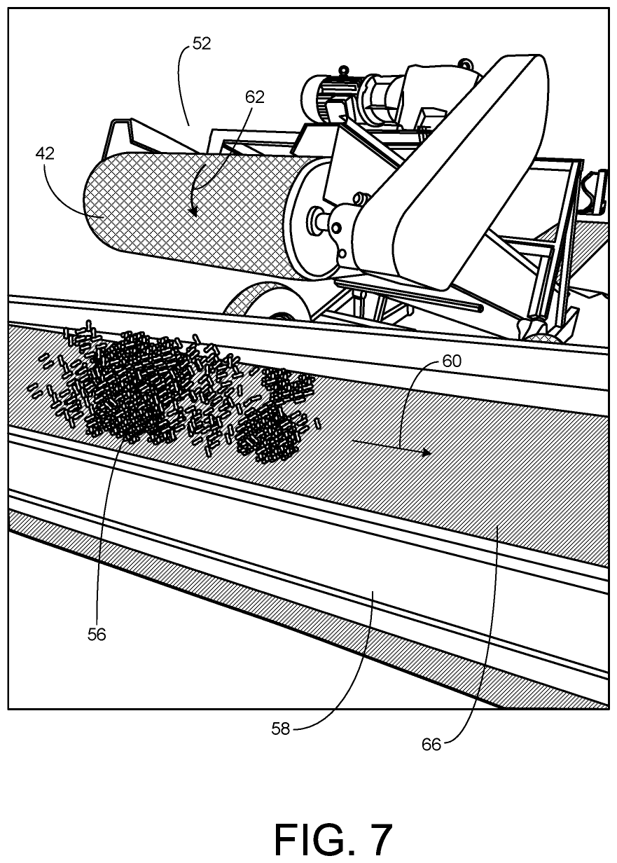

FIG. 8 illustrates the potato hog and its table conveyor in greater detail.

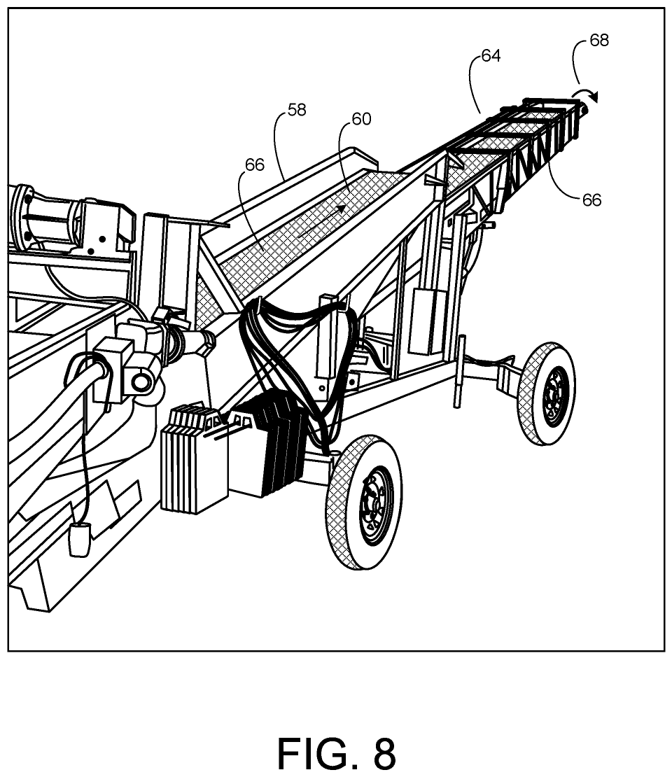

### DISCLOSURE

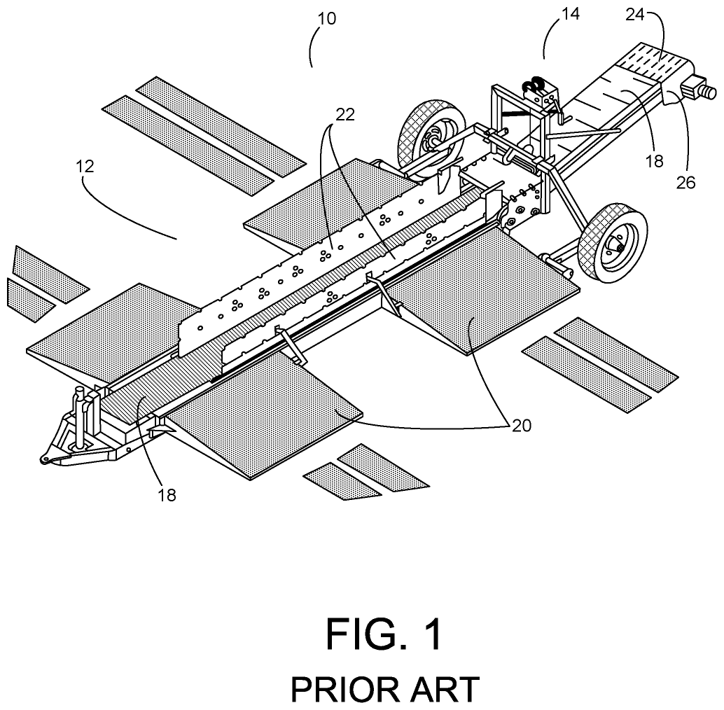

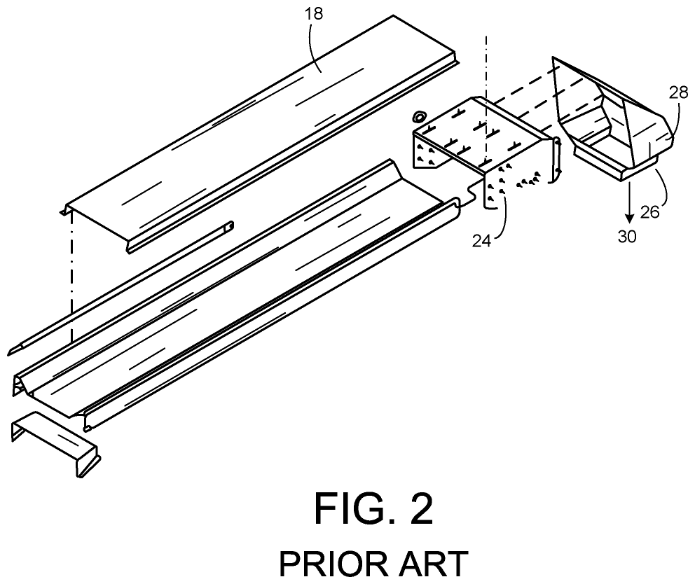

Referring to the drawings wherein like numerals represent like elements, there is shown in FIGS. 1 and 2 relevant details of the above noted prior art drive over conveyor, labeled generally 10. Conveyor 10 has a lower conveyor portion 12 and an upper conveyor portion 14. A belt 16 extends from the loading area of the lower conveyor portion 12 (i.e., the area between trailer ramps 20) to the discharge end of the upper conveyor portion 14. A cover 18 is disposed over the upper conveyor portion 14. The width of the conveyor belt is 16 inches and is driven by a drive system at a fixed, non-adjustable speed, using a 3.5 inch diameter pulley. Trailer ramps 20 allow a trailer (not shown) to be pulled over the belt 16 to deposit the trailer contents (i.e., product, such as grain or peanuts) via a hopper underneath the trailer (not shown). The lower conveyor portion 12 has retractable walls 22 that are lowered as the trailer is pulled over the belt 16, then raised after the trailer is in position to deposit its contents. Disposed at the discharge end of upper conveyor portion 14 is an elbow shaped hood 26 connected thereto by a frame 24. Product strikes the elbow 28 and is thus discharged vertically downward (direction 30) by the hood 26.

Previous studies have revealed that the above prior art system exerts a force of about 0.0177 ft-lb on the product as it is discharged from the drive over conveyor and strikes the elbow 28. While this striking action may not be harmful to seeds or grain, it can damage peanuts by causing the shells to crack or break open. Previous studies have also revealed that the safe amount of force that can be exerted on a peanut without cracking, even if they strike the hood, is about 0.003 ft-lb, or about 6 times less than the amount of force that is normally applied by the conveyor system. Desirably, the amount of force applied to the peanuts as they are discharged should be low enough to prevent them from striking the hood. In addition, the throughput of the conveyor system should not be sacrificed by lowering the speed of the conveyors to reduce the discharge force on the peanuts.

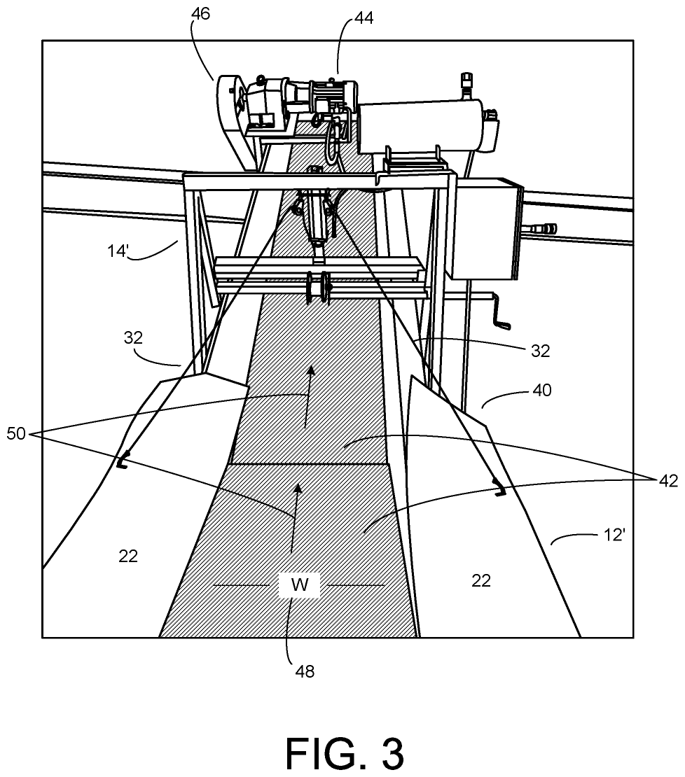

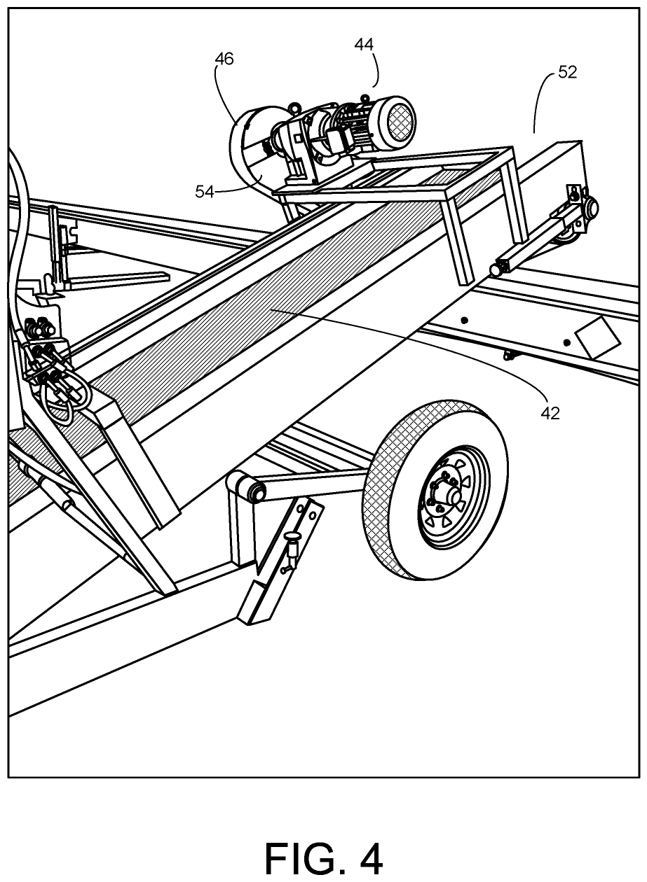

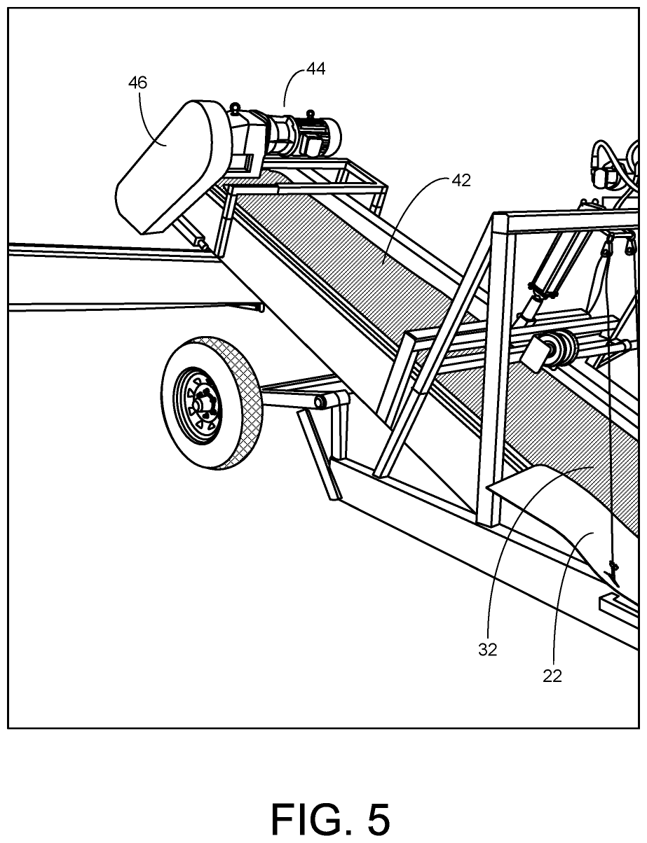

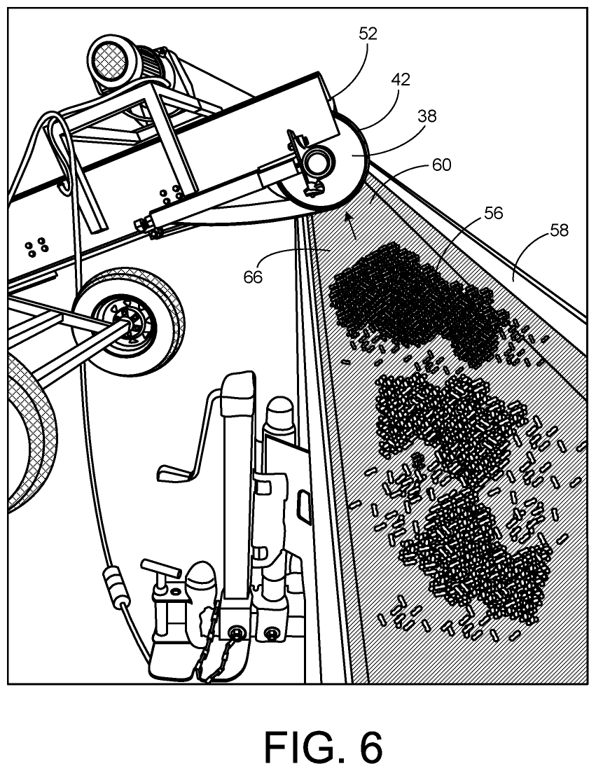

Referring to FIGS. 3-6, there is shown a conveyor system 40 that overcomes the noted problems with using the prior art conveyor system to transport peanuts. The conveyor system 40 has a lower portion 12′ and an upper portion 14′, and employs a belt 42 to convey peanuts from the lower portion to the upper portion via an adjustable speed drive system 46 that employs a variable speed motor 44. The speed of the motor 44 (and hence the drive system 46) is adjusted by a speed controller (not shown). Adjusting the speed of the motor adjust the speed of the belt 42 and hence the amount of force that peanuts experience as they are discharged. As shown, peanuts 56 deposited on the belt 42 are transported in direction 50 toward another conveyor system 58, i.e., the table conveyor of the potato hog. The walls 22 are shown in the lowered position, This position allows the trailer to drive over the belt 42 to deposit the peanuts onto the loading area of the conveyor system. Once the trailer is in position over the belt, the walls are raised by cables 32, and peanuts are permitted to flow onto the belt.

The width 48 of the belt 42 is 36 inches, which increases the efficiency of the conveyor system relative to the prior art conveyor. The diameter of the roller 38 that engages with the belt 42 is 14″ There is another roller (not shown) at the opposing (loading area) end of the conveyor having a diameter of 5″. At the discharge end 52, the peanuts are discharged from the belt 42 as the belt rotates in direction 62. The speed of the drive system 46 is adjusted such that the force exerted on peanuts being discharged by the belt system 42 is about 0.00074 ft-lb. In this manner, up to one ton per minute of peanuts can be safely transported by the conveyor system 40. in view of the wider belt system 42 and the larger diameter of the pulley 54, the unloading capacity of the conveyor system 40 matches that of the above prior art conveyor, even though the conveyor speed, and the force exerted on the peanuts, are substantially lower. As a result of the significantly lower force exerted on the peanuts as they are discharged, they drop onto the belt 66 in a gentle fashion, rather than being directed onto the belt by striking the elbow 28 (as would occur in the prior art conveyor). Accordingly, the hood 26 is no longer necessary. Additionally, the cover 18 is not required. Thus, throughput is maintained without damaging peanuts, and therefore efficiency is increased.

The table conveyor of the potato hog transports the peanuts in direction 60, where they are deposited onto another portion of the potato hog for discharge 68 at their storage location. The width of the belt 66 is the same as the width of the belt 42. Due to the adjustable speed of drive system 46, the speed of the belt 42 can be synchronized with the speed of the belt 66, such that there is uniformity in amount of peanuts conveyed from the loading end to the final discharge end

The apparatus described herein may be embodied in other specific forms without departing from the spirit or essential attributes thereof. Accordingly, reference should be made to the appended claims, rather than the foregoing specification, for indicating the scope of the invention.

What is claimed is:

1. A conveyor system for transporting peanuts from a loading area to a storage area comprising:
a) a first conveyor system having a first conveyor belt that extends from a loading area to a discharge area;
b) a second conveyor system having a second conveyor belt adapted to be placed adjacent and below the discharge area of the first conveyor system, the second conveyor system adapted to extend to an intended storage location for the peanuts, the first and second conveyor belts having substantially the same width;
c) a first, adjustable speed drive system for driving the first conveyor belt at an adjustable speed and a second drive system for driving the second conveyor belt at a fixed speed, the speed of first conveyor belt being adjusted to substantially match the fixed speed of the second conveyor belt; and, d) the speed of the first conveyor belt being further adjusted so as to exert a force of no greater than about 0.003 ft-lb on the peanuts being discharged at the discharge area of the first conveyor system.

2. The conveyor system of claim 1 wherein the speed of the conveyor belts is such that up to one ton of peanuts per minute may be delivered from the loading area to the intended storage location.

3. The conveyor system of claim 1 wherein the speed of the first conveyor belt is adjusted so as to exert of force of no greater than about 0.00074 ft-lb on the peanuts being discharged at the discharge area of the first conveyor system.

4. The conveyor system according to claim 1 wherein the width of the first and second conveyor belts is about sixteen inches.

5. The conveyor system according to claim 1 wherein, as a result of the speed at which peanuts are being conveyed on the first conveyor belt, no hood is required to cause the peanuts to be discharged onto the second conveyor belt.

6. A drive over conveyor for transporting peanuts, via a first conveyor belt, from a loading area adapted to receive peanuts deposited from a trailer, to a discharge area for discharging peanuts from the conveyor belt onto another conveyor system that transports peanuts discharged from the drive over conveyor via a second conveyor belt to a storage location, the drive over conveyor system comprising an adjustable speed drive system coupled to the first conveyor belt for adjusting the speed of the first conveyor belt, the first conveyor belt having a width substantially the same as the width of the second conveyor belt, the speed of the first conveyor belt being adjusted to substantially match the speed of the second conveyor belt, the speed of the first conveyor belt being further adjusted so as to exert a force of no greater than about 0.003 ft-lb on peanuts being discharged at the discharge area of the drive over conveyor system and further such that no apparatus is required at the discharge area to direct peanuts onto the second conveyor belt.

7. The drive over conveyor of claim 6 wherein the speed of the conveyor belts is such that up to one ton of peanuts per minute may be delivered from the loading area to the storage location.

8. The drive over conveyor system of claim 6 wherein the speed of the first conveyor belt is adjusted so as to exert of force of no greater than about 0.00074 ft-lb on the peanuts being discharged at the discharge area of the drive over conveyor system.

9. The drive over conveyor system of claim 6 wherein the width of the first and second conveyor belts is about sixteen inches.

10. A conveyor system for transporting peanuts from a loading area to a storage area comprising:
a) a drive over conveyor having a first conveyor belt that extends from a loading area adapted to receive peanuts deposited from a trailer to a discharge area;
b) another conveyor system, defining a potato hog, having a second conveyor belt adapted to be placed adjacent and below the discharge area of the drive over conveyor, the potato hog adapted to extend to an intended storage location for the peanuts, the first and second conveyor belts having a width of about sixteen inches;
c) a first, adjustable speed drive system for driving the first conveyor belt at an adjustable speed, and a second drive system for driving the second conveyor belt at a fixed speed, the speed of first conveyor belt being adjusted to substantially match the fixed speed of the second conveyor belt, the speed of the first conveyor belt being further adjusted so as to exert a force of about 0.00074 ft-lb on peanuts being discharged at the discharge area of the drive over conveyor, and further such that no apparatus is required at the discharge area to direct peanuts onto the second conveyor belt, and further such that up to one ton of peanuts per minute may be delivered from the loading area to the storage location.
